(19) United States
(12) Patent Application Publication
(10) Pub. No.: US 2021/0285694 A1
(43) Pub. Date: Sep. 16, 2021

(54) Method of Using Catalyzed Graphene with Nanoparticle Reacting Agent to Improve the Efficiency of a Thermal Vapor Compression System

(71) Applicants: Clay Manley, Bailey Island, ME (US); Julie Manley, Bailey Island, ME (US)

(72) Inventors: Clay Manley, Bailey Island, ME (US); Julie Manley, Bailey Island, ME (US)

(21) Appl. No.: 17/337,553

(22) Filed: Jun. 3, 2021

Related U.S. Application Data
(63) Continuation-in-part of application No. 16/495,481, filed on Sep. 19, 2019.
(60) Provisional application No. 62/485,367, filed on Apr. 13, 2017.

(51) Int. Cl. F25B 9/00; C10M 125/02; C10M 171/00

(52) U.S. Cl. CPC F25B 9/006; B82Y 30/00; C10M 171/008; C10M 125/02

(57) ABSTRACT

The process relates to a method of using catalyzed graphene with a nanoparticle reacting agent in the refrigeration circuit of a thermal vapor compression system to improve the efficiency of the system. Specifically, the present process relates to a method of using a catalyzed graphene and nanoparticle reacting agent in the refrigeration circuit of an air conditioning, heat pump, or refrigeration system to increase the performance of the system relative to an equivalent system operating in an equivalent environment without the catalyzed graphene and nanoparticle reacting agent.

### CROSS-REFERENCE TO RELATED APPLICATIONS

This application takes benefit of U.S. Prov. App. 62/485,367 filed 13 Apr. 2017; Patent Cooperation Treaty (PCT) application PCT/US18/26926 filed 10 Apr. 2018; and U.S. National Stage application Ser. No. 16/495,481 filed 19 Sep. 2019 each of which is hereby incorporated in its entirety.

### FIELD OF THE INVENTION

The present invention relates to a method of using catalyzed graphene with a nanoparticle reacting agent in the refrigeration circuit of a thermal vapor compression system to improve the efficiency of the system. Specifically, the present invention relates to a method of using a catalyzed graphene and nanoparticle reacting agent in the refrigeration circuit of an air conditioning, heat pump, or refrigeration system to increase the performance of the system relative to an equivalent system operating in an equivalent environment without the invention.

### BACKGROUND OF THE INVENTION

There is a critical need for advanced cooling and thermal dissipation systems capable of operating with greater energy efficiency while simultaneously meeting the needs of increasingly demanding new applications. Even modest enhancements in thermal efficiency can produce huge energy savings when implemented on a global scale.

Since heat transfer fluids are the primary contributors to thermal performance, there is interest in developing advanced formulations that display superior thermal properties. Specifically, interest has recently been directed toward a class of colloidal suspensions comprised of ultrafine metal or nonmetallic nanoparticles.

Efforts have focused on understanding the unusual thermophysical behavior of these so called “nano fluids” by characterizing governing parameters associated with the particles (material, shape, size, concentration), bulk fluid properties (composition, pH, temperature, stabilizing additives), and interactions among the suspended components. These discoveries have poised nanofluid-based technologies as ideal candidates for incorporation in a host of applications ranging from microelectronics to engine coolants to the remediation of oily soil deposits.

Therefore, what is needed is a method of using catalyzed graphene and nanoparticles as a reacting agent in refrigeration circuits to decrease the amount of electricity consumed by an air conditioning, heat pump, and refrigeration system.

Also, what is needed, is a method of using catalyzed graphene with nanoparticles as a reacting agent in refrigeration circuits to decrease the cycle time that a compressor operates to achieve a particular temperature set point and thus provide more services for the same energy input.

Generally, what is needed is a method of using catalyzed graphene and nanoparticles as a reacting agent in refrigeration circuits to improve the efficiency of an air conditioning, heat pump, or refrigeration system.

### SUMMARY OF THE INVENTION

The exemplary embodiment of the present invention comprises a method of using catalyzed graphene and nano particles as a reacting agent added to the refrigeration circuit of an air conditioning, heat pump, or refrigeration system to improve the efficiency of the air conditioning, heat pump, or refrigeration system. The catalyzed graphene and nanoparticle reacting agent used in the exemplary embodiment is Nano LiquiTec from Deutsche Nano LiquiTec, GmbH.

In the exemplary embodiment of the present invention, Nano LiquiTec is added to the low-pressure side of the cooling circuit of the air conditioning, heat pump, or refrigeration system. The system is allowed to equilibrate for a period of time to allow Nano LiquiTec to mix with the refrigerant fluid in the air conditioning, heat pump, or refrigeration system.

The air conditioning, heat pump, or refrigeration system is then operated in the usual manner. The exemplary embodiment of the present invention demonstrates in an air conditioning split system approximately 29% greater coefficient of performance (COP) and a 40% increase in cooling capacity (kw).

### DETAILED DESCRIPTION OF THE PREFERRED EMBODIMENT

The exemplary embodiment of the present invention comprises a method of using catalyzed graphene and nanoparticles as a reacting agent added to the refrigeration circuit of an air conditioning, heat pump, or refrigeration system to improve the efficiency of the vapor compression system. The catalyzed graphene and nanoparticles reacting agent used in the exemplary embodiment is Nano LiquiTec from Deutsche Nano LiquiTec, GmbH.

The Nano LiquiTec catalyzed graphene and nanoparticle additive that causes this improved performance is a polyalphaolefin (PAO) synthetic base oil with catalyzed graphene and nanoparticles admixed in the absence of oxygen under a tank-based nitrogen blanket. The Nano LiquiTec catalyzed graphene and nanoparticle additive may be added either to active refrigerant (installed in an existing cooling system) or new compressor oil (for installation in new compressor systems). Nano LiquiTec catalyzed graphene and nanoparticle additive may be used to increase the efficiency of air conditioning compressors. Functionally, the Nano LiquiTec catalyzed graphene and nanoparticle additive increases refrigerant molecule size and lowers the refrigerant boiling point to reduce lubricant viscosity breakdown. The lifetime of lubricants treated with Nano LiquiTec catalyzed graphene and nanoparticle additive is greatly increased.

In the exemplary embodiment of the present invention, 50 ml of Nano LiquiTec is added to the low-pressure side of the cooling circuit of a typical air conditioning system. The specific air conditioning system is a York split type air conditioning system Model YSL09C3 AMH01 with a rated cooling capacity of 3 kW utilizing R22 refrigerant. The air conditioning system has a nominal amount of R22 refrigerant fluid installed. The cooling system is allowed to equilibrate for a period of time to allow the Nano LiquiTec product to mix with the refrigerant fluid in the air conditioning system.

The air conditioner serviced a 43 m³ space with a heat load influence of constant outdoor ambient air temperature. A temperature controller is attached. The temperature controller is set for cooling at 25 degrees Celsius.

The operation of the system is measured before and after the addition of the Nano LiquiTec using a ClimaCheck measurement system operated by a registered professional refrigeration engineer. For each test, the analyzer collected data on the following operating conditions over a 3-hour period at 30-second intervals:
Power input
Cooling capacity
COP
Comp lsen Eff
Amperage
Suction temperature and pressure
Discharge temperature and pressure
Super heat
Sub cool
Ref mass flow gm/s
Ref volume flow m³/h

The air conditioning system is operated in the usual manner. The exemplary embodiment of the present invention demonstrates the following operational data:

| Average Readings (Run Only) | Before | Post | Change |
|---|---|---|---|
| Low Pressure (bar) | 4.8 | 5 | 4% |
| Suction (° C.) | 10.7 | 11 | 3% |
| Super heat (K) | 5.8 | 5.2 | 10% |
| Condenser in (° C.) | 30.9 | 31.9 | 3% |
| Condenser out (° C.) | 44.5 | 45.7 | 3% |
| High pressure (bar) | 17.2 | 18.1 | 5% |
| Sub cool (K) | 14.4 | 16.1 | 12% |
| Discharge (° C.) | 96.8 | 85 | 12% |
| Comp Isen Efficiency (%) | 52.5 | 68.8 | 31% |
| Power (kw) | 0.8 | 0.9 | 13% |
| COP cool | 3.1 | 4 | 29% |
| CAP cool (kw) | 2.5 | 3.5 | 40% |
| Amps | 3.8 | 4 | 5% |
| Minutes off | 46 | 55.5 | 21% |
| Ref mass flow (gm/s) | 15.4 | 22.3 | 45% |
| Ref volume flow (m3/h) | 2.3 | 3.3 | 43% |

The exemplary embodiment of the present invention shows measurably improved performance after the Nano LiquiTec was added. For example, the system showed approximately 29% greater coefficient of performance (COP) and a 40% increase in cooling capacity (kw). All operational parameters are improved: 1) Power input was 13% greater; 2) Compressor discharge temperature decreased by 12% post test data; 3) Comp Isen Eff % increased significantly by 31% post test data; 4) COP cool (a ratio of the cooling capacity and power input) increased significantly by 29% post test data; 5) Sub cooling K increased by 12% post test data; 6) Capacity cool kw increased significantly by 40% post test data. This indicates a significant improvement in overall system performance; 7) Amperage increased by 5% post test data; 8) Compressor run time decreased by 21% post test data; 9) Refrigerant mass flow gm/s increased significantly by 45% post test data; 10) Refrigerant volume flow m³/h increased significantly by 43% post test data.

The primary reason that the Nano LiquiTec caused improved performance was because the system exhibited generally lower oil fouling and by the effect of the graphene and the nanoparticles on the refrigerant molecules.

It will be readily apparent that the exemplary embodiment is not the only embodiment of the present invention which may be constructed. For example, it is also contemplated that the present invention may be used with heat pump air conditioning systems.

What is claimed is:

1. A method of using a catalyzed graphene and nanoparticle reacting agent in refrigeration circuits comprising:
a) adding polyalphaolefin (PAO) synthetic base oil with catalyzed graphene and nanoparticles admixed in the absence of oxygen under a nitrogen blanket as a reacting agent to the low-pressure side of a refrigeration circuit; and
b) operating the refrigeration circuit to alter the temperature of a space.

2. A method of using catalyzed graphene and nanoparticle reacting agent in refrigeration circuits of claim 1 wherein the refrigeration circuit comprises a conventional oil lubricated compressor.

3. A method of using catalyzed graphene and nanoparticle reacting agent in refrigeration circuits of claim 1 wherein the refrigeration circuit comprises an air conditioning heat pump.

4. A method of using catalyzed graphene and nanoparticle reacting agent in refrigeration circuits of claim 1 wherein the refrigeration circuit comprises an oil-less air conditioning system such as those with magnetic bearings.

5. A method of using a catalyzed graphene and nanoparticle reacting agent in compressor oil comprising:
a) adding polyalphaolefin (PAO) synthetic base oil with catalyzed graphene and nanoparticles admixed in the absence of oxygen under a nitrogen blanket as a reacting agent to the compressor oil in the compressor; and
b) operating the compressor to alter the pressure within a space.
